(19) United States
(12) Patent Application Publication
(10) Pub. No.: US 2026/0077818 A1
(43) Pub. Date: Mar. 19, 2026

(54) VEHICLE LOWER STRUCTURE

(71) Applicant: TOYOTA JIDOSHA KABUSHIKI KAISHA, Aichi-ken (JP)

(72) Inventor: Katsunori HIGASHIHARA, Toyota-shi (JP)

(21) Appl. No.: 19/310,929

(22) Filed: Aug. 27, 2025

(30) Foreign Application Priority Data
Sep. 17, 2024 (JP) 2024-160072

(51) Int. Cl. B62D 25/20; B60K 1/04

(52) U.S. Cl. CPC B62D 25/2072; B60K 1/04; B60K 2001/0438

(57) ABSTRACT

A vehicle lower structure includes: a battery case, having a body part accommodating a battery and a flange part protruding from an outer peripheral side of the body part, the battery case having a portion configuring an upper surface side that also functions as a vehicle floor panel; a framework part of a vehicle lower part to which the flange part of the battery case is joined; and a cover member that is fixed to the body part of the battery case, and that has a cover part disposed between the body part of the battery case and the framework part at a vehicle upper side relative to the flange part.

### CROSS-REFERENCE TO RELATED APPLICATION

This application is based on and claims priority under 35 USC 119 from Japanese Patent Application No. 2024-160072 filed on Sep. 17, 2024, the disclosure of which is incorporated by reference herein in its entirety.

### BACKGROUND

### Technical Field

The present disclosure relates to a vehicle lower structure.

### Related Art

A configuration in which a battery case is arranged in the lower part of a vehicle is known (see, for example, Chinese Patent Application Publication No. 115703508 and Japanese Patent Application Laid-open No. 2022-38401). Chinese Patent Application Publication No. 115703508 discloses a technology relating to a vehicle lower structure in which a battery case functions as a vehicle body floor. Briefly, in this prior art, a battery case is connected to a framework part of a lower part of a vehicle.

Incidentally, in a structure in which a battery case functioning as the vehicle body floor and a framework part of the vehicle lower part are connected, there may be cases in which a flange part extending from the body part of the battery case is connected to the skeleton part.

However, in such a structure, there is a possibility that rust may be produced as a result of water droplets or the like that have accumulated in the flange part at the peripheral part of the main body part of the battery case, and there is room for improvement in this regard.

### SUMMARY

The present disclosure provides a vehicle lower structure capable of improving rust prevention performance in a peripheral part of a main body part of a battery case.

A vehicle lower structure according to a first aspect includes: a battery case, having a body part accommodating a battery and a flange part protruding from an outer peripheral side of the body part, the battery case having a portion configuring an upper surface side that also functions as a vehicle floor panel; a framework part of a vehicle lower part to which the flange part of the battery case is joined; and a cover member that is fixed to the body part of the battery case, and that has a cover part disposed between the body part of the battery case and the framework part at a vehicle upper side relative to the flange part.

According to the vehicle lower structure according to the first aspect, the body part of the battery case houses the battery, a flange part protrudes from an outer peripheral side of the body part of the battery case, and furthermore, a portion configuring an upper surface side of the battery case serves as a floor panel of the vehicle. Furthermore, the flange part of the battery case is connected to the framework part of the lower part of the vehicle. Here, a cover member is fixed to the body part of the battery case, and a cover part of the cover member is arranged at a vehicle upper side with respect to the flange part and between the body part of the battery case and the framework part. For this reason, it is possible to prevent water droplets or the like from accumulating at the flange part at a peripheral part of the body part of the battery case by means of the cover part of the cover member, and it is possible to suppress the occurrence of rust at the peripheral part of the body part of the battery case.

A vehicle lower structure according to a second aspect has the configuration described in the above-described first aspect, in which the cover part has a groove part extending along a direction orthogonal to a protrusion direction of the flange part, which is directly below the cover part in vehicle plan view.

According to the vehicle lower structure according to the second aspect, since the cover part has a groove part extending in a direction orthogonal to the protrusion direction of the flange part that is immediately below the cover part in plan view of the vehicle, water that would flow from the outer peripheral side of the body part of the battery case toward the framework part side can be accumulated in the groove part. As a result, even in a case in which the floor part of the vehicle is wettened with a large amount of water or the like, generation of rust at the peripheral part of the body part of the battery case can be suppressed.

A vehicle lower structure according to a third aspect has the configuration described in the above-described second aspect, in which the groove part has a water gradient inclined toward a vehicle lower side toward at least one end part side in a direction of extension of the groove part.

According to the vehicle lower structure according to the third aspect, since the groove has a water gradient that is inclined toward the vehicle lower side toward at least one end part side in the extension direction of the groove part, owing to the water gradient, water entering the groove part can be made to flow in a predetermined direction and discharged.

A vehicle lower structure according to a fourth aspect has the configuration described in the above-described third aspect, in which the framework part has a pair of rockers provided at respective side parts of the vehicle lower part in a vehicle width direction and extending along a vehicle front-rear direction, the flange part of the battery case is joined to the pair of rockers, the cover part is provided at an end part side of the battery case in the vehicle width direction and is disposed between the body part of the battery case and the rockers, and the groove part extends along the vehicle front-rear direction.

According to the vehicle lower structure according to the fourth aspect, the flange part of the battery case is connected to the pair of rockers. The cover member has a cover part that is provided at an end part side of the battery case in the vehicle width direction, and is disposed between the body part of the battery case and the rockers, and the cover part has a groove part extending in the vehicle front-rear direction. By providing the groove part along the longitudinal direction of the vehicle in this way, it is possible to sufficiently secure the volume that can be accumulated in the groove.

A vehicle lower structure according to a fifth aspect has the configuration described in the above-described fourth aspect, in which the framework part has a cross member spanning between the pair of rockers, the flange part of the battery case is joined to the cross member, the battery case has an upper case configuring an upper part of the battery case and a lower case configuring a lower part of the battery case, and the flange part is configured by joining an upper flange part of the upper case with a lower flange part of the lower case, a first seal part that seals between the upper flange part and the lower flange part is provided, and a second seal part is provided that seals between the cross member and a portion of the flange part of the battery case at a distal end side further in the protrusion direction than the first seal part, the upper flange part of the upper case has a step part between the first seal part and the second seal part, and a portion further toward a distal end part side than the step part is configured lower in a vehicle vertical direction than a portion further toward a proximal end part side than the step part, and the groove part has a water gradient that directs received water toward a side of the step part.

According to the vehicle lower structure according to the fifth aspect, the flange part of the battery case is joined to the cross member. A first seal part seals between an upper flange part and a lower flange part, and a second seal part seals between a portion of the flange part of the battery case at the distal end side in the protrusion direction with respect to the first seal part, and the cross member. Furthermore, the upper flange part of the upper case has a step part between the first seal part and the second seal part, and a portion closer to the distal end part than the step part is set lower in the vehicle vertical direction than a portion closer to the proximal end part than the step part. Here, since the groove has a water gradient such that received water is directed toward the step part side, water flowing into the groove part can flow toward the step part side at the side part side of the battery case in the vehicle width direction, and water dropping on the upper flange part can be suppressed from flowing to the body part side.

As described above, according to the vehicle lower structure of the present disclosure, there is the effect that the rust prevention performance in the peripheral part of the main body part of the battery case can be improved.

### BRIEF DESCRIPTION OF THE DRAWINGS

An exemplary embodiment of the present disclosure will be described in detail based on the following figures, wherein:

FIG. 1 is a plan view showing a simplified vehicle lower structure according to an embodiment;

FIG. 2 is a cross-sectional view showing a simplified state sectioned along line 2-2 of FIG. 1;

FIG. 3 is a cross-sectional view showing a simplified state sectioned along line 3-3 of FIG. 1; and

FIG. 4 is a perspective view showing a simplified portion at a front end side of a cover member.

### DETAILED DESCRIPTION

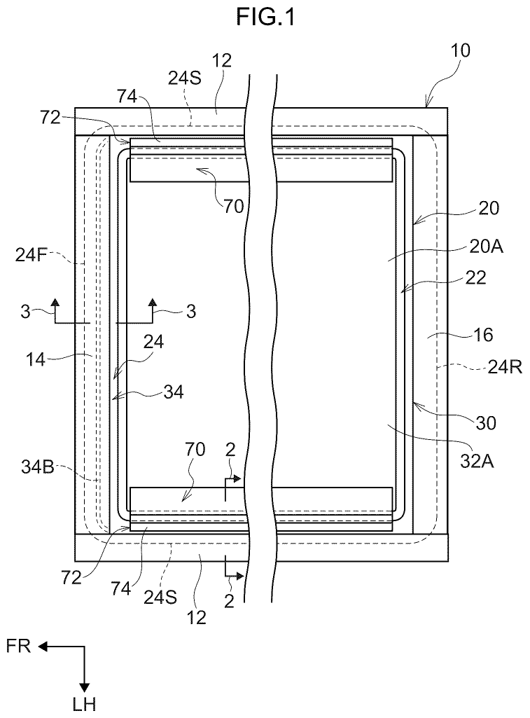

Hereinafter, a vehicle lower structure according to an embodiment will be described with reference to FIGS. 1 to 4. Note that arrows FR, UP, and LH, which are shown as appropriate in the drawings, indicate the forward direction (traveling direction) of the vehicle, the upward direction, and the left side of the vehicle, respectively. Hereinafter, when simply described using front-rear, up-down, and left-right directions, unless otherwise specified, it is assumed that the front-rear direction of the vehicle, the up-down direction of the vehicle, and the left-right direction of the vehicle are indicated. Furthermore, in the respective drawings, some reference numerals may be omitted for ease of understanding of the drawings.

### Configuration of Embodiment

FIG. 1 shows a simplified plan view of a vehicle lower structure of an electric vehicle. As shown in FIG. 1, a framework part 10 of a lower part of a vehicle has a pair of rockers 12 provided at respective side parts of the vehicle lower part in the vehicle width direction and extending along the vehicle front-rear direction, and a pair of cross members 14, 16 spanning between the pair of rockers 12 and arranged to be spaced from each other in the vehicle front-rear direction. Note that in FIG. 1, for convenience, the illustration of intermediate parts in the vehicle front-rear direction, such as the framework part 10, is omitted. Further, in the drawing, among the pair of cross members 14, 16, the cross member (front cross member) arranged at the front side is denoted by reference numeral 14, and among the pair of cross members 14, 16, the cross member (rear cross member) arranged at the rear side is denoted by reference numeral 16. The front cross member 14 connects the front end parts of the left and right rockers 12 in the vehicle width direction, and the rear cross member 16 connects the rear end parts of the left and right rockers 12 in the vehicle width direction.

A body part 22 of a battery case 20 is arranged between the pair of cross members 14, 16 and between the pair of rockers 12. In the battery case 20, a part constituting the upper surface 20A side also serves as a floor panel of the vehicle, and the body part 22 of the battery case 20 is formed in a box shape which is thin in the vehicle vertical direction, with the vehicle front-rear direction as a longitudinal direction.

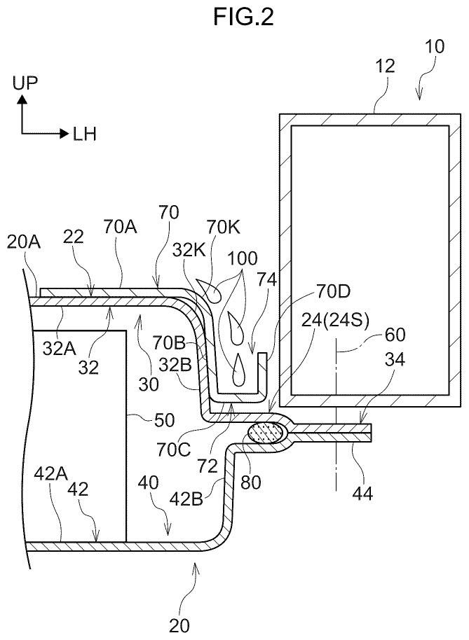

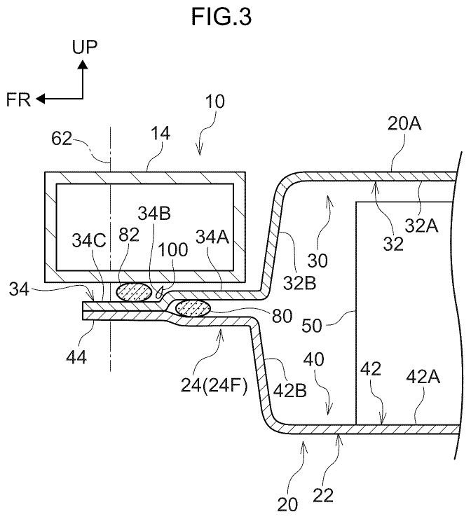

FIG. 2 shows a simplified cross-sectional view in a state sectioned along line 2-2 of FIG. 1. As shown in FIG. 2, the body part 22 of the battery case 20 houses the battery 50. The battery 50 is a secondary battery. FIG. 3 shows a simplified cross-sectional view in a state sectioned along line 3-3 of FIG. 1. As shown in FIGS. 1 to 3, the battery case 20 has a flange part 24 which protrudes from the outer peripheral side of the body part 22.

As shown in FIG. 1, as an example, the flange part 24 is formed around the entire circumference of the battery case 20. In the following description, for convenience, a part of the flange part 24 constituting the front end part of the battery case 20 may be referred to as a front flange part 24F, a part of the flange part 24 constituting the rear end part of the battery case 20 may be referred to as a rear flange part 24R, and a part of the flange part 24 constituting an end part of the battery case 20 in the vehicle width direction may be referred to as a side flange part 24S.

As shown in FIGS. 2 and 3, the battery case 20 has an upper case 30 constituting an upper part of the battery case 20 and a lower case 40 constituting a lower part of the battery case 20. The upper case 30 is a part constituting the upper surface 20A side of the battery case 20, and is provided with a box-shaped upper case body part 32 which is arranged such that a vehicle lower side is open, and an upper flange part 34 which protrudes from the open end of the upper case body part 32. The upper case body part 32 has a top plate part 32A which is substantially rectangular in plan view and an upper peripheral wall part 32B which is formed continuously with the peripheral end part of the top plate part 32A. The lower case 40 has a box-shaped lower case body part 42 which is arranged such that a vehicle upper side is open, and a lower flange part 44 which protrudes from the open end of the lower case body part 42. The lower case body part 42 is provided with a bottom plate part 42A which is substantially rectangular in plan view and a lower peripheral wall part 42B which is formed continuously with the peripheral end part of the bottom plate part 42A.

The upper flange part 34 of the upper case 30 and the lower flange part 44 of the lower case 40 are connected to form a flange part 24 of the battery case 20. Furthermore, the upper case body part 32 of the upper case 30 and the lower case body part 42 of the lower case 40 constitute the body part 22 of the battery case 20.

The flange part 24 of the battery case 20 is coupled to the pair of rockers 12 and the pair of cross members 14, 16 constituting the framework part 10 of the vehicle lower part shown in FIG. 1. The side flange part 24S of the battery case 20 shown in FIG. 2 is fixed to the rocker 12 by bolt fastening in a position displaced in the vehicle front-rear direction with respect to the cross-section of FIG. 2 (in the drawing, a bolt fastening line is shown by a dot-dash line 60). Furthermore, the front flange part 24F of the battery case 20 shown in FIG. 3 is connected to the front cross member 14 by bolt fastening in a position displaced in the vehicle width direction with respect to the cross-section of FIG. 3 (in the drawing, a bolt fastening line is shown by a dot-dash line 62). Furthermore, the rear flange part 24R of the battery case 20 shown in FIG. 1 is connected to the rear cross member 16 by bolt fastening (a fastener is not shown). The connection structure between the battery case 20 and the rear cross member 16 is, for example, substantially the same as the connection structure between the battery case 20 and the front cross member 14.

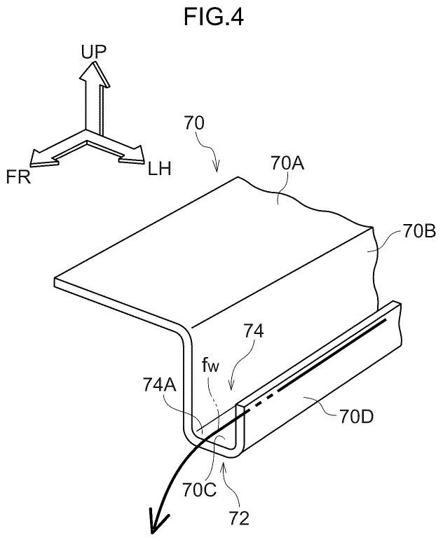

Further, a cover member 70 extending along the vehicle front-rear direction is provided at the end part side of the battery case 20 in the vehicle width direction. The cover member 70 is provided as a left and right side pair and is fixed to the body part 22 of the battery case 20. The cover member 70 is a member made of resin or metal (for example, steel) and is composed of an elongate plate material. The pair of left and right cover members 70 is formed symmetrically, as an example. FIG. 4 shows a simplified perspective view of a front end portion of the cover member 70 attached to the left side of the battery case 20. Note that in FIG. 4, directions in the state in which the cover member 70 is fixed to the battery case 20 (see FIG. 2) are indicated by the arrow FR, the arrow UP, and the arrow LH.

As shown in FIG. 4, the cover member 70 is formed in a bent plate shape. In other words, the cover member 70 is provided with a flat plate-shaped upper plate part 70A, a pendent part 70B bent toward the vehicle lower side from an end part of the upper plate part 70A at an outer side in the vehicle width direction, a bottom plate part 70C bent from the lower end part of the pendent part 70B toward the outer side in the vehicle width direction, and an upright part 70D bent from an end part of the bottom plate part 70C at the outer side in the vehicle width direction toward the vehicle upper side.

As shown in FIG. 2, the cover member 70 is arranged so that a corner part 70K, which serves as a boundary part between the upper plate part 70A and the pendent part 70B, is positioned on the outer surface side of the corner part 32K, which serves as a boundary part between the top plate part 32A of the upper case 30 and the upper peripheral wall part 32B. The upper plate part 70A of the cover member 70 is fixed to the vehicle width direction outer side part of the top plate part 32A of the upper case 30 in a state of being overlaid from the vehicle upper side by, for example, welding.

Further, the cover member 70 has a cover part 72 which is arranged on the vehicle upper side with respect to the flange part 24 (side flange part 24S) between the body part 22 of the battery case 20 and the rocker 12 of the skeleton part 10. Furthermore, as shown in FIG. 1, the cover part 72 has a groove part 74 extending in a direction orthogonal to the protrusion direction of the flange part 24 (side flange part 24S) that is immediately below the cover part 72 in a plan view of the vehicle. In other words, the groove 74 extends along the vehicle front-rear direction. The groove 74 is an element which can be understood as a water receiving part.

Furthermore, in the present embodiment, as shown in FIG. 3, a first seal part 80 for sealing between the upper flange part 34 and the lower flange part 44 is provided. The first seal part 80 is provided on the side of the body part 22 with respect to a central position between the proximal end and the distal end of the flange part 24 of the battery case 20. Furthermore, between the flange part 24 of the battery case 20 and the front cross member 14, a second seal part 82 is provided to seal between a portion at the distal end side of the flange part 24 of the battery case 20 further in the protrusion direction than the first seal part 80 and the front cross member 14. Further, the upper flange part 34 of the upper case 30 has a step part 34B between the first seal part 80 and the second seal part 82, and a part 34C on the distal end part side with respect to the step part 34B is set lower in the vehicle vertical direction than a part 34A on the proximal end part side with respect to the step part 34B.

While not shown in the drawings, the structure of the portion including the rear flange part 24R of the battery case 20 and the rear cross member 16 shown in FIG. 1, as an example, has substantially the same configuration as a structure in which the structure of the portion including the front flange part 24F of the battery case 20 and the front cross member 14 shown in FIG. 3 is reversed to front and rear.

As shown in FIG. 4, the groove 74 has a water gradient which is inclined toward the vehicle lower side toward one end side in the extension direction of the groove 74 (in the present embodiment, as an example, the front end part 74A side (the front end part side in the vehicle front-rear direction)), and has a water gradient such that received water is directed toward the side of the step part 34B (see FIGS. 1 and 3). Note that in FIG. 4, the arrow fw indicated by a two-dot chain line schematically shows the direction in which the liquid flows when a liquid such as water enters the groove 74.

### Mechanism and Effects of Embodiment

Next, the mechanism and effects of the above-described embodiment will be described.

In the present embodiment, the body part 22 of the battery case 20 shown in FIG. 1 houses a battery 50 (see FIG. 2), a flange part 24 protrudes from an outer peripheral side of the body part 22 of the battery case 20, and furthermore, a part constituting the upper surface 20A side of the battery case 20 serves as a floor panel of the vehicle. Furthermore, the flange part 24 of the battery case 20 is coupled to the framework part 10 of the lower part of the vehicle. Here, a cover member 70 is fixed to the body part 22 of the battery case 20, and a cover part 72 of the cover member 70 is arranged on the vehicle upper side with respect to the flange part 24 between the body part 22 of the battery case 20 and the framework part 10. Therefore, by means of the cover part 72 of the cover member 70, it is possible to prevent water droplets or the like from accumulating at the flange part 24 at the peripheral part of the body part 22 of the battery case 20, and it is possible to suppress occurrence of rust at the peripheral part of the body part 22 of the battery case 20.

Furthermore, in the present embodiment, the cover part 72 has a groove part 74 extending in a direction orthogonal to the protrusion direction of the flange part 24 that is immediately below the cover part 72 in plan view of the vehicle. As a result, as shown in FIG. 2, water 100, which would flow from the outer peripheral side of the body part 22 of the battery case 20 toward the framework part 10 side, can be accumulated in the groove part 74. As a result, even when the floor part of the vehicle is wettened with a large amount of water or the like, generation of rust at the peripheral part of the body part 22 of the battery case 20 can be suppressed.

Furthermore, in the present embodiment, as shown in FIG. 4, the groove part 74 has a water gradient which is inclined toward the vehicle lower side toward one end part side (the front end part 74A side) in the extension direction of the groove part 74. As a result, water entering the groove 74 can be made to flow in a predetermined direction (see the arrow fw) and discharged owing to the water gradient.

Furthermore, in the present embodiment, as shown in FIG. 1, among the flange parts 24 of the battery case 20, the side flange part 24S is joined to a pair of rockers 12 constituting a part of the framework part 10. Furthermore, the cover member 70 is provided at an end part side of the battery case 20 in the vehicle width direction, the cover part 72 of the cover member 70 is arranged between the body part 22 of the battery case 20 and the rocker 12, and the groove 74 of the cover part 72 extends along the vehicle front-rear direction. By providing the groove 74 along the longitudinal direction of the vehicle in this way, it is possible to sufficiently secure a volume that can be accumulated in the groove 74.

Furthermore, in the present embodiment, as shown in FIG. 3, a space between the upper flange part 34 and the lower flange part 44 of the battery case 20 is sealed by a first seal part 80. Furthermore, a space between a portion on the distal end side in the protrusion direction in the front flange part 24F of the battery case 20 with respect to the first seal part 80 and the front cross member 14 is sealed by a second seal part 82. Further, the upper flange part 34 of the upper case 30 has a step part 34B between the first seal part 80 and the second seal part 82, and a part 34C on the distal end part side with respect to the step part 34B is set lower in the vehicle vertical direction than a part 34A on the proximal end part side with respect to the step part 34B. Here, the groove part 74 shown in FIG. 4 has a water gradient such that received water is directed toward the side of the step part 34B (see FIGS. 1 and 3). For this reason, water flowing in the groove 74 at the side part side of the battery case 20 in the vehicle width direction shown in FIG. 1 can be guided to flow to the side of the step part 34B shown in FIG. 3, and water 100 that has fallen on the upper flange part 34 can be kept from flowing toward the body part 22 side of the battery case 20.

As described above, according to the vehicle lower structure of the present embodiment, the rust prevention performance in the peripheral part of the body part 22 of the battery case 20 can be improved.

### Supplementary Description of Embodiments

Note that, in the above-described embodiment shown in FIGS. 1 to 4, the groove 74 has a water gradient which is inclined toward the vehicle lower side toward the front end part 74A side, which is one end part side in the extension direction of the groove part 74; however, as a modification of the above-described embodiment, a configuration may be adopted in which, for example, a groove part, provided in the same position as the groove part 74 of the above-described embodiment in vehicle plan view, has a water gradient inclined toward the vehicle lower side toward the rear end side, which is one end side in the extension direction of the groove part, or has two water gradients inclined toward the vehicle lower side toward the front end side and the rear end side in the direction in which the groove extends.

Further, as another modification of the above-described embodiment, a configuration may be adopted in which, for example, a groove part, provided in the same position as the groove part 74 of the above-described embodiment in vehicle plan view, has no water gradient inclined toward the vehicle lower side toward one end side in the extension direction of the groove part.

Furthermore, in the above-described embodiment, the cover part 72 has a groove part 74 extending in a direction orthogonal to the protrusion direction of the flange part 24 (the side flange part 24S) that is immediately below the cover part 72 in plan view of the vehicle, and although this kind of configuration is preferable, as a modification of the above-described embodiment, a configuration may be adopted in which the cover part does not have a groove part extending in a direction orthogonal to the protrusion direction of the flange part 24 that is immediately below the cover part in plan view of the vehicle.

Furthermore, as a modification of the above-described embodiment, a water absorbing material may be provided on the outer surface side of the step part 34B of the upper flange part 34 of the upper case 30.

Furthermore, in the above-described embodiment, the battery case 20 includes an upper case 30 having a box-shaped upper case body part 32 which is arranged so that the vehicle lower side is open; however, as a modification of the above-described embodiment, a configuration may be adopted such that the battery case has, in place of the upper case 30 of the above-described embodiment, an upper member which does not include a box-shaped part and which serves as a floor panel, and further, instead of the lower case 40 of the above-described embodiment, has a lower case having a depth which allows the entire battery to be housed therein.

Furthermore, in the above-described embodiment, although a cover member extending along the vehicle width direction is not provided at the end part side of the battery case 20 in the vehicle front-rear direction, a cover member extending along the vehicle width direction may be provided at the end part side of the battery case 20 in the vehicle front-rear direction. In other words, the vehicle lower structure may include a configuration in which a cover member is fixed to an end part side of the body part 22 of the battery case 20 in the vehicle front-rear direction, and the cover member extends along the vehicle width direction, and further, has a cover part arranged on the vehicle upper side with respect to the flange part 24 of the battery case 20 between the body part 22 of the battery case 20 and the cross member 14,16. Furthermore, in this kind of configuration, the cover part may have a groove part extending in a direction orthogonal to the protrusion direction of the flange part 24 that is immediately below the cover part in vehicle plan view (i.e., extending in the vehicle width direction).

Note that the above-described embodiment and the plural modified examples described above can be appropriately combined and implemented.

While an example of the present disclosure has been described above, it is of course the case that the present disclosure is not limited to the foregoing, and can be practiced with various modifications made thereto in a range that does not depart from the gist thereof.

What is claimed is:

1. A vehicle lower structure, comprising:
a battery case, having a body part accommodating a battery and a flange part protruding from an outer peripheral side of the body part, the battery case having a portion configuring an upper surface side that also functions as a vehicle floor panel;
a framework part of a vehicle lower part to which the flange part of the battery case is joined; and
a cover member that is fixed to the body part of the battery case, and that has a cover part disposed between the body part of the battery case and the framework part at a vehicle upper side relative to the flange part.

2. The vehicle lower structure of claim 1, wherein the cover part has a groove part extending along a direction orthogonal to a protrusion direction of the flange part, which is directly below the cover part in vehicle plan view.

3. The vehicle lower structure of claim 2, wherein the groove part has a water gradient inclined toward a vehicle lower side toward at least one end part side in a direction of extension of the groove part.

4. The vehicle lower structure of claim 3, wherein:
the framework part has a pair of rockers provided at respective side parts of the vehicle lower part in a vehicle width direction and extending along a vehicle front-rear direction,
the flange part of the battery case is joined to the pair of rockers,
the cover part is provided at an end part side of the battery case in the vehicle width direction and is disposed between the body part of the battery case and the rockers, and
the groove part extends along the vehicle front-rear direction.

5. The vehicle lower structure of claim 4, wherein:
the framework part has a cross member spanning between the pair of rockers,
the flange part of the battery case is joined to the cross member,
the battery case has an upper case configuring an upper part of the battery case and a lower case configuring a lower part of the battery case, and the flange part is configured by joining an upper flange part of the upper case with a lower flange part of the lower case,
a first seal part that seals between the upper flange part and the lower flange part is provided, and a second seal part is provided that seals between the cross member and a portion of the flange part of the battery case at a distal end side further in the protrusion direction than the first seal part,
the upper flange part of the upper case has a step part between the first seal part and the second seal part, and a portion further toward a distal end part side than the step part is configured lower in a vehicle vertical direction than a portion further toward a proximal end part side than the step part, and
the groove part has a water gradient that directs received water toward a side of the step part.
